(19) United States
(12) Patent Application Publication
(10) Pub. No.: US 2015/0136799 A1
(43) Pub. Date: May 21, 2015

(54) PROCESS FOR MANUFACTURING A STORAGE TANK PANEL

(71) Applicant: Samuel, Son & Co., Limited, Mississauga (CA)

(72) Inventors: Tamo P. Bianchi, Oakville (CA); William A. Willsher, Stoney Creek (CA)

(21) Appl. No.: 14/535,361

(22) Filed: Nov. 7, 2014

Related U.S. Application Data
(60) Provisional application No. 61/904,554, filed on Nov. 15, 2013.

(51) Int. Cl. B21K 23/04; B23K 10/00; B21J 7/18; B21B 1/22; B21D 5/14

(52) U.S. Cl. CPC B21K 23/04; B21B 1/224; B21D 5/14; B21J 7/18; B23K 10/00
USPC 220/669; 72/203

(57) ABSTRACT

A process for manufacturing a curved panel for use in constructing a cylindrical storage tank is described. In an embodiment of the process, a flat plate is automatically conveyed into a CNC cutting station to form all bolt holes and cut-out features and to trim the plate to a defined outer dimension. After the cutting station, the plate is automatically conveyed into a roll-forming line configured to form parallel flanges long both longitudinal edges of the plate. Respective leading end regions of the two flanges may undergo a swaging operation by a pair of laterally opposing hydraulically-powered swage dies to form an integral chime region of each flange. After the swaging operation, the plate is automatically conveyed into a roll bending unit configured to curve the flanged plate into an arc to form a finished panel.

### FIELD OF THE INVENTION

The present application relates generally to storage tanks for storing liquids and granular solids (dry bulk commodities), and more particularly to storage tanks constructed of curved steel panels.

### BACKGROUND OF THE INVENTION

Large cylindrical storage tanks for liquids and granular solids may be constructed from a plurality of panels that are curved in the form of an arc and are fastened together. For example, a tank may have six panels connected end-to-end, each covering a sixty-degree arc, to form the circumference of the tank. The panels may be stacked vertically to provide a desired tank height. By way of further example, a storage tank may be four panels high, with each level having six circumferential panels, such that twenty-four panels are required in total to construct the tank. The arc angle and number of panels needed to form the circumference are adjustable depending on the tank design. Similarly, the number of height levels is subject to design choice.

Each tank panel is provided with a pair of parallel flanges, one along each longitudinal edge of the panel. A plurality of bolt holes are provided through each flange for attachment of the panel to adjacent panels above and below, to a supporting base structure below, and/or to a roof structure above. Further groups of bolt holes are provided at each opposite end of the panel across the width of the panel for attachment of the panel end-to-end with adjacent panels in the same height level of the tank structure. Each flange is provided with “chime region” offset toward the longitudinal centerline of the panel at one end of the panel to accommodate slight overlap of an adjacent panel for bolted connection of the panels.

Each panel may be formed from an elongated rectangular piece of steel plate on the order of forty feet long by ten feet wide. Plate thickness may vary depending on the tank requirements, and it is known to use ¼ inch, 5/16 inch, and ⅜ inch steel plate among other possible thicknesses. A piece of steel plate that is 40 ft×10 ft×3/8 in weighs approximately 6,126 pounds.

It is known to form flanges in a metal plate using a press brake. With a plate approaching forty feet in length, it is challenging and time consuming to form two parallel flanges along opposite longitudinal edges using a press brake. A first flange must be formed, and then the plate must be removed from the press brake and rotated 180 degrees to engage the opposite edge in the press brake to form the second flange. Sequential formation of flanges in this manner introduces quality control problems wherein the flanges are not parallel with one another to a suitable tolerance. Moreover, handling of the large plate to switchover from one edge to the other involves time, material handling equipment, and significant operator skill. Use of a press brake to form the flanges is not ideal from either a quality standpoint or an efficiency standpoint. Use of a press brake to form the flanges also imposes a length limitation on the panel.

Making the chime region of each flange may involve further operations. For example, a notch may be cut in the plate at the corresponding corner, and a separately fabricated chime piece may be welded to the corner portion of the plate to provide the chime region. Of course, this must be repeated at the opposite corner.

As may be appreciated, poor quality and lack of consistency in the formed panels will cause delays during tank construction and possibly result in tank leakage. What is needed is a more efficient and economical process of making flanged curved panels for a cylindrical storage tank, wherein the resulting panels are of consistently high quality.

### SUMMARY OF THE INVENTION

The present invention provides a process for manufacturing flanged curved panels that overcomes the problems mentioned above while reducing the cost and time invested in making the panels relative to prior methods.

In an embodiment of the present invention, a flat plate is automatically conveyed into a CNC cutting station, which may include a high definition plasma cutter or laser cutter, to form all bolt holes and cut-out features (i.e. doors, inlet and outlet pipe holes), and to trim the plate to a defined outer dimension. After the cutting station, the plate is automatically conveyed into a roll-forming line configured to progressively bend both longitudinal edges of the plate to form parallel longitudinal flanges. When the leading end of the plate exits out of the roll-forming line, respective leading end regions of the two flanges may undergo a swaging operation by a pair of opposing hydraulically-powered swage dies each acting in a direction lateral to the flow direction of the plate through the roll-forming line. The swaging operation forms an integral chime region of each flange. After the swaging operation, the plate is automatically conveyed into a roll bending unit configured to curve the flanged plate into an arc to form a finished panel. A movable cradle shaped to support the curved panel may be actuated to receive and support the panel, and to move the panel to a position wherein the panel may be transferred to a shipping crate specially designed to securely hold a plurality of nested panels.

As may be appreciated, the process of the present invention avoids the use of a press brake and provides repeatable formation of highly parallel flanges. The process may also avoid a welding operation associated with forming the chime regions. Operator skill is largely removed from the process, resulting in greater uniformity in the manufactured panels.

### BRIEF DESCRIPTION OF THE DRAWING VIEWS

Features and advantages of embodiments of the present disclosure will become apparent by reference to the following detailed description and drawings, in which:

FIG. 1 is a schematic plan view of an equipment layout for manufacturing curved storage tank panels in accordance with an embodiment of the present invention;

FIG. 2 is a flow diagram of a manufacturing process embodying the present invention;

FIG. 3 is an orthogonal view illustrating a swaging step of the process for forming a chime region of a panel; and

FIG. 4 is a perspective view illustrating a shipping crate for storing and transporting completed panels.

### DETAILED DESCRIPTION OF THE INVENTION

The present invention provides a process for manufacturing curved panels for use in constructing large cylindrical storage tanks for storing contents such as liquids and dry bulk commodities in granular form. As one non-limiting example, the panels made by the disclosed process may be used to construct water storage tanks.

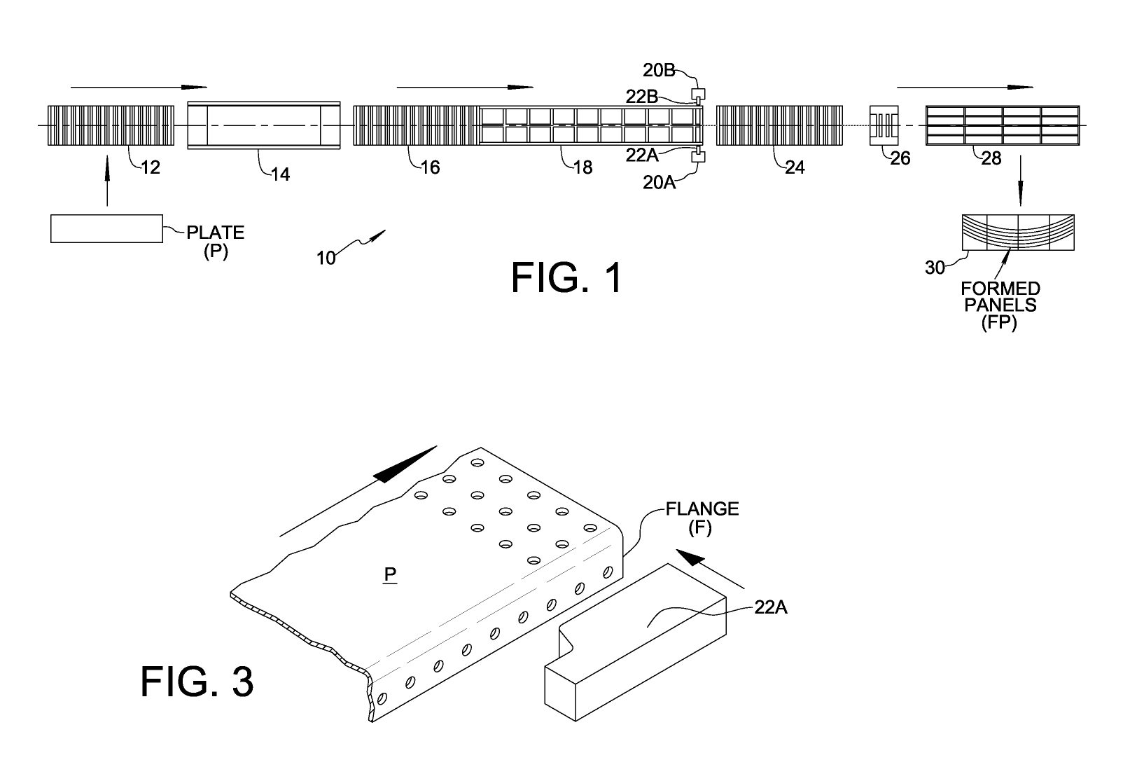

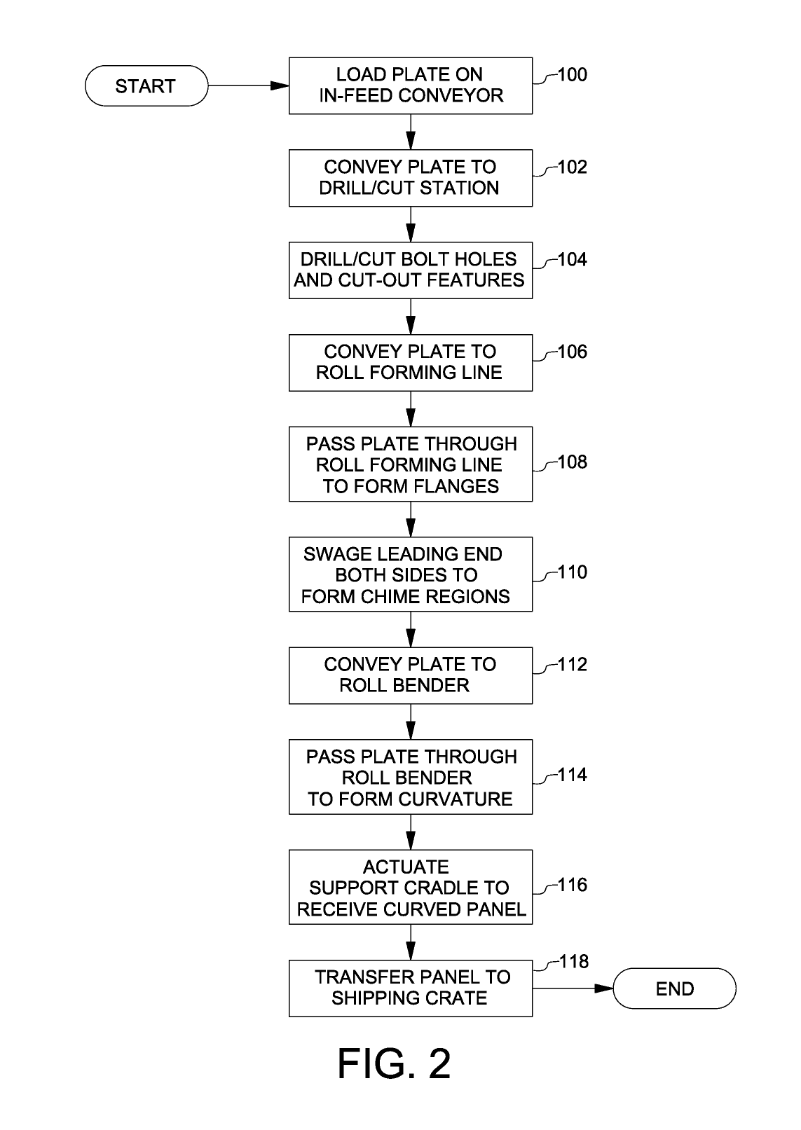

FIG. 1 schematically illustrates an embodiment of an equipment layout 10 for carrying out the process of the present invention, and FIG. 2 is a flow diagram showing an embodiment of the process. Equipment layout 10 defines a process flow path. In the current embodiment, the flow path defined by equipment layout 10 proceeds in a straight line along a flow direction from left to right in FIG. 1. A straight process flow path is advantageous because it avoids the need for lateral transfer of plates P and associated equipment. However, a straight process flow path may be too long to fit within a given plant facility, and it is within the scope of the invention to alter equipment layout 10 to provide a process flow path having changes in flow direction.

Each panel is formed from a large plate of steel P. The dimensions of plate P will depend on the overall dimensions of the tank to be constructed. For purposes of indicating an order of magnitude, it is understood that plates P may be on the order of forty feet long by ten feet wide by ⅜ inches thick. These dimensions are subject to variation depending on the tank design.

Initially, a flat plate P received from a steel mill is loaded onto an automated in-feed conveyor 12 of equipment layout 10. The loading may be carried out using a plate-lifting hoist supported by an overhead traveling gantry. The loading step is designated as step 100 in FIG. 2.

In-feed conveyor 12 feeds the flat plate P forward (to the right in FIG. 1) into a CNC cutting station 14. This is step 102 in FIG. 2. Cutting station 14 is configured to form all bolt holes, manway doors, inlet pipe holes, and outlet pipe holes. Cutting station 14 is further configured to trim or crop the outside edge portions of plate P to give the plate a predetermined length and width. Cutting station 14 may be a high definition plasma cutting station, a laser cutting station, a drilling station, or a station combining any or all of the foregoing technologies. Cutting station 14 may be embodied as a single machinery cell, for example a high-definition plasma cutter or a laser cutter, programmed to form all holes and doors in the part and to crop the part. Use of only a single machine for cutting station 14 avoids the need for additional space and conveying equipment associated with an additional machine. Applicant currently favors use of a high definition plasma cutter available from Pinnacle Industrial Automation Inc. of Guelph, Ontario having a specialized motion drive system that essentially eliminates slag formation at the bottom of formed holes (slag will interfere with a subsequent roll-forming step described below).

Once all holes and cut-out features have been formed and the plate trimmed by cutting station 14 in accordance with step 104, plate P is conveyed out of cutting station 14 by an automated conveyor 16, which in turn conveys the plate into a roll-forming line 18. The conveyance of plate P from cutting station 14 to roll-forming line 18 is labeled step 106 in FIG. 2.

Roll-forming line 18 comprises a plurality of roll-forming stations configured to progressively bend the longitudinal edges of plate P to form a pair of parallel flanges F extending the length of plate P (a leading end portion of one flange F is visible in FIG. 3). Roll-forming line 18 may comprise a suitable roll forming equipment line having a series of roll-forming stations sequentially arranged along one after another along the process flow path. The formation of flanges F by roll-forming line 18 is designated as step 108 in FIG. 2.

Equipment layout 10 may comprise a pair of swaging stations 20A, 20B located on opposite sides of the flow path. Swaging stations 20A, 20B may be configured and tooled with corresponding swage dies 22A, 22B and corresponding swage blocks (not shown) to perform a swaging operation upon a leading end region of each flange F on opposite sides of plate P. FIG. 3 schematically illustrates the swaging step at a leading end region of one of the flanges, just prior to impact. Each swaging station 20A, 20B is operable to force a corresponding swaging die 22A, 22B laterally relative to the flow path direction to force a respective flange F against an associated swage block (not shown) to form a desired chime region configuration. This step is labeled 110 in FIG. 2. In this manner, a chime region of the tank panels may be formed to allow for sealant to be accommodated at areas where panels overlap one another in the assembled tank. Swaging stations 20A, 20B may be hydraulically powered stations located directly opposite each other at a location along the process flow path where flanges F are fully formed. In the present embodiment, swaging stations 20A, 20B are located at an output end of roll-forming line 18, which is advantageous in minimizing the overall length of the process path. As an alternative, swaging stations 20A, 20B may be located downstream from the output end of roll-forming line 18.

With respect to steps 108 and 110, it is highly desirable that all tank panels, and thus plates P, have a standard width because this will avoid set-up time needed to reconfigure roll-forming line 18 and swaging stations 20A, 20B to accommodate a different plate width. Moreover, it is desirable to choose a plate width that is a standard mill size, e.g. 120 inches, to avoid cost and delay associated with procuring custom plate sizes.

From swaging stations 20A, 20B, the flanged plate P is conveyed by an automated conveyor 24 into a roll bending unit pursuant to step 112 in FIG. 2.

Roll bending unit 26 includes a configuration of parallel pinch rollers for curving flanged plate P into an arc. For example, plate P may be curved to form a sixty-degree arc to define a portion of a tank circumference. This step is designated by reference numeral 114 in FIG. 2. The arc can be adjusted to increase or decrease the circumference or the diameter of the tank. By way of non-limiting example, bending unit 26 may be a three-roll pyramid bending unit or a four-roll bending unit.

As the curved and flanged plate P emerges from bending unit 26, it may be supported by a vertically and horizontally movable cradle 28 positionable at an exit end of bending unit 26. Cradle 28 may be shaped to receive and support the curved and flanged plate P so as prevent damage to the plate and deviation of the formed curvature. In the present embodiment, cradle 28 is initially actuated to a receiving position near bending unit 26. Once the curved and flanged plate P is received by cradle 28, the cradle is actuated to retract the cradle from bending unit 26 and lower the cradle to the ground. The cradling operation is designated by step 116 in FIG. 2.

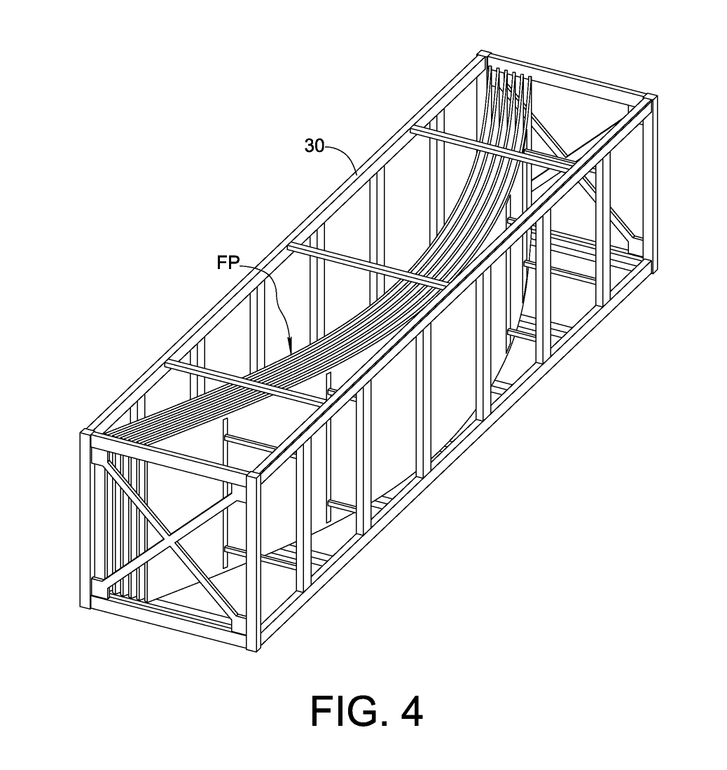

Finally, the plate (now referred to as a formed panel FP), is safely transferred to a shipping crate 30 for transport to a site where blasting and coating may be performed in accordance with step 118 in FIG. 2. Transfer may be carried out by an overhead magnetic or suction hoist to avoid damage to the formed panel FP. As best seen in FIG. 4, crate 30 provides a supporting framework for maintaining curvature of the formed panels FP, and is dimensioned to hold a plurality of nested panels. In the current embodiment, crate 30 is designed to hold six nested panels FP, however crate 30 may be designed to hold a different quantity of panels.

While the invention has been described in connection with exemplary embodiments, the detailed description is not intended to limit the scope of the invention to the particular forms set forth. The invention is intended to cover such alternatives, modifications and equivalents of the described embodiment as may be included within the spirit and scope of the invention.

What is claimed is:

1. A process for manufacturing a curved panel for use in constructing a cylindrical storage tank, the process comprising the steps of:
(A) conveying a flat metal plate into a CNC cutting station;
(B) operating the CNC cutting station to form all holes and cut-out features in the flat plate;
(C) passing the flat plate through a roll forming line having a plurality of sequentially arranged roll-forming stations to form a pair of parallel flanges along opposite longitudinal edges of the plate;
(D) passing the flanged plate through a pair of opposed swaging stations to perform a swaging operation upon respective leading end regions of the pair of parallel flanges to form a respective chime region on each of the pair of the flanges; and
(E) passing the flanged plate through a roll bending unit having a configuration of parallel pinch rollers to curve the flanged plate into an arc, whereby the flanged and curved plate is a formed curved panel.

2. The process according to claim 1, wherein the flat metal plate is automatically conveyed into the CNC cutting station.

3. The process according to claim 1, wherein the CNC cutting station is further operated to trim at least one edge of the flat plate.

4. The process according to claim 1, wherein the flat plate is automatically conveyed from the CNC cutting station into the roll forming line.

5. The process according to claim 1, wherein the pair of opposed swaging stations are located at an output end of the roll-forming line.

6. The process according to claim 1, wherein the flanged plate is automatically conveyed from the pair of opposed swaging stations into the roll bending unit.

7. The process according to claim 1, wherein a vertically and horizontally movable cradle is operated to receive and support the formed curved panel as it emerges from the roll bending unit.

8. A curved panel product for use in constructing a cylindrical storage tank, the product being manufactured by the process of claim 1.
